(19) United States
(12) Patent Application Publication
(10) Pub. No.: US 2007/0116801 A1
(43) Pub. Date: May 24, 2007

(54) Low-alcohol beer or beer-like refreshment beverages containing palatinose

(76) Inventors: Jörg Kowalczyk, Eisenberg-Steinborn (DE); Tillman Dorr, Hohen-Sulzen (DE); Lutz Guderjahn, Offstein (DE); Hartmut Evers, Bad Kreuznach (DE); Jan-Karl Nielebock, Dortmund (DE)

Correspondence Address: OSTROLENK FABER GERB & SOFFEN, 1180 AVENUE OF THE AMERICAS, NEW YORK, NY, 100368403, US

(21) Appl. No.: 10/583,481

(22) PCT Filed: Dec. 17, 2004
(86) PCT No.: PCT/EP04/14402

§ 371 Date: Oct. 16, 2006

(30) Foreign Application Priority Data
Dec. 19, 2003 (DE) 103 61 313.7

(51) Int. Cl. C12C 11/00

(52) U.S. Cl. 426/16

(57) ABSTRACT

The present invention relates to methods for producing a low-alcohol or alcohol-free beer or a beer-like soft drink as well as a low-alcohol or alcohol-free beer or beer-like soft drink produced through the use of this method.

The present invention provides methods for producing a low-alcohol or alcohol-free beer or beer-like soft drink, and a low-alcohol or alcohol-free beer or beer-like soft drink produced through the use of this method.

For years, there has been a trend in beer consumption away from the conventional beer with normal alcohol content and towards beverages with substantially lower alcohol content. This is evident, for example, from the decrease in beer sales in Germany, while the sales of beer-mix beverages, shandy beverages, and beverages with lower alcohol content, in particular alcohol-free beers, are on the rise.

Beer-mix beverages are usually obtained by mixing beer and appropriately aromatized sugar syrups, which leads to beverages that are very rich in calories. In part, beer-mix beverages are produced through the use of sweetener-containing syrups. However, flavor tests have shown that the beer-mix beverages containing sweetener-containing syrups are inferior to sugar-containing beer-mix beverages. However, the use of sugar syrups for producing beer-mix beverages is disadvantageous, since the fermentable sugars used in beer production require extremely harsh filtration and/or pasteurization or other preservation of the beverages. Pasteurization, though, is associated with increased investments in fixed assets and increased energy or water consumption and reduces the sensory flavor profile.

Alcohol-free beers with 7% to 8% original wort are currently produced mainly by early discontinuation of the fermentation at an alcohol content 0.5% by vol. or from beer by alcohol depletion to a level of 0.5% by vol. In the discontinued fermentation, the fermentation is discontinued by cooling to 0° C. and the yeast is removed. However, beers of this type are not very agreeable and do not show a round beer flavor.

Mainly vacuum evaporation or membrane facilities are used in the alcohol depletion procedure. In most cases, the beverages obtain a bread-like taste in the process, which is also known as “Pasteur flavor”. Depending on which alcohol depletion method is used, false aromas may be evident such that the beers have an empty flavor or lack of character. Moreover, the methods are disadvantageous also because of their increased costs, since the cost of distillation and vacuum generation add to the customary brewing costs.

The methods described in DE 22 25 270 B2 and AT 300 698 are associated with similar disadvantages. In the method described in DE 22 25 270 B2, oxygen or an oxygen-containing gas is guided into a wort prepared from grain or maize mashes, whereby the fermentation is carried out, at least in part, aerobically as a yeast fermentation. In the method described in AT 300 698, different temperatures are used in the main fermentation, a diastase solution is added, and the spent yeast is replaced by fresh yeast such that approx. one third of the wort ferments in the first phase of the main fermentation to a fermentation degree of 40% to 85% at a temperature of 4° C. to 8° C., and thereafter the alcohol content is depleted by boiling to approx. 1% by weight. In a second phase, the fermentation is completed after adding a grenzdextrinases-fortified diastase solution. Both methods also lead to beverages with a flavor which is untypical of beer.

Similarly, the currently employed methods, in which reverse osmosis is used to deplete the alcohol in the beer, produce alcohol-free or low-alcohol beers that hardly attain the flavor quality of classical full-alcohol content beers.

Moreover, a method for producing a low-alcohol beer-like beverage is known from the patent specification DE 23 44 252 C3, in which a mixture of the wort and 6-α-glucosidofructofuranose (palatinose) is fermented, whereby the mixing ratio of original wort content and palatinose is in the range of 2:1 to 1:2. Beers produced by this method also do not have a sufficiently complete aromatic fullness of flavor.

In summary, it is evident that the currently known production of reduced-alcohol or alcohol-free beers is very resource-consuming and therefore expensive. The costs are increased not only because of the investments into facilities for alcohol depletion, but also by the requisite higher water consumption and ensuing higher waste water and energy costs. Moreover, the flavor of the known alcohol-free beers is not at the same level as the flavor of a conventional beer.

The present invention is therefore based on the technical problem to provide methods for producing low-alcohol or alcohol-free beers or beer-like soft drinks, that comprise a fullness of aromatic flavor adequate to full-alcohol beer and are also suitable for diabetics, whereby the methods can be used without additional investments into fixed assets, in particular without additional alcohol depletion facilities, in normal brewing operations.

The present invention solves the underlying technical problem by providing a method for producing a low-alcohol or alcohol-free beer or a beer-like soft drink, whereby a wort is produced by mixing brewing liquor, hop, and a carbohydrate source in a first step, the wort is boiled in a second step, and the wort is subjected to a fermentation process in a third step, characterized in that a palatinose-containing mixture or palatinose is added before, during or after the fermentation process, and whereby at least one microorganism selected from the group consisting of a bottom fermentation Saccharomyces cerevisiae strain, a top fermentation Saccharomyces cerevisiae strain, Saccharomyces carlsbergensis, Saccharomyces diastaticus, and Brettanomyces intermedius, is used for fermenting.

The method according to the invention is characterized in that the alcohol content of the low-alcohol or alcohol-free beer or beer-like soft drink thus produced is reduced by means of several different procedural steps. On the one hand, palatinose or a palatinose-containing mixture is added to the wort before, during or after the fermentation process. Palatinose is a reducing sugar that possesses not only improved organoleptic properties as compared to sucrose, but also is not at all or very poorly assimilated or metabolized by microorganisms such as Saccharomyces cerevisiae or Saccharomyces carlsbergensis. Accordingly, in particular in the embodiments of the method according to the invention, in which the palatinose is added before or during the fermentation, a part of the wort is replaced by palatinose such that the alcohol content of the beverage produced by the fermentation is reduced as compared to a normal beer.

On the other hand, not only the customary microorganisms of beer production, Saccharomyces cerevisiae (e.g MJJ 25) and Saccharomyces carlsbergensis (e.g. MJJ 9, MJJ 11), are used for fermentation, but microorganisms with a lesser fermentation performance, such as Saccharomyces diastaticus and Brettanomyces intermedius, are also used. Whereas the classical brewing procedure for producing full-alcohol content beer solely uses yeast cultures of the type Saccharomyces cerevisiae or, occasionally, bottom fermentation strains thereof, also called S. carlsbergensis, preferred embodiments of the method according to the invention use mixtures of different microorganisms. The invention also provides, in further preferred embodiments, for the use of microorganisms that ferment fermentable sugars without generating alcohol, but rather, for example, lactic acid, or reduce the alcohol obtained by yeast fermentation, in addition to the above-mentioned microorganisms, in particular yeasts. According to the invention this also affords a reduction of the alcohol content of the beverages produced by the use of the method according to the invention.

Thus, according to the invention by the microorganisms palatinose is not fermented or fermented only very slowly or with late onset, such that only little or no alcohol is formed, respectively.

For the process according to the invention those microorganisms are of particular use, which in a process according to the one described below ferment only 10 to a maximum of 30% of the palatinose provided within 11 days. According to this process, used to detect the most preferred microorganisms according to the invention, yeasts to be tested are cultivated in 100 ml of beer wort, pH 5.1 at 30° C. for 24 hours. After cultivation the cells are centrifuged off (10 min, 4000×g), and the cell pellet is resuspended in 10 ml palatinose medium, consisting of 67 g/l yeast nitrogen base (Difco) and 50 g/l palatinose, pH 5.1. The cells are washed twice in the same medium and then resuspended in 5 ml medium. Of this cell suspension 100 μl are inoculated in 1 liter palatinose medium and cultivated at 30° C. for 11 days. After the 11-day cultivation the remainder palatinose is determined by HPAEC.

In addition, a further reduction of the alcohol content of the beverages thus produced is achieved in a preferred embodiment of the method according to the invention by the wort containing, in part, raw grain, i.e. non-malted grain. Since the starting materials used for beer production must first be converted into sugars prior to fermentation, whereby the enzymes required for this process are generated during the malting, the use of raw grain leads to a lower sugar content and thus to a lower alcohol content after fermentation.

Thus, through the use of the method according to the invention, low-alcohol or alcohol-free beers can be produced in a relatively easy fashion; these beers can be bottom fermentation or top fermentation alcohol-free or low-alcohol beers depending on which microorganism/microorganisms is/are used for fermentation. Since the wort used for fermentation can contain different carbohydrate sources, light or dark alcohol-free or low-alcohol beers can also be produced by the use of the method according to the invention. The alcohol content of the beers produced according to the invention can be reduced further, if applicable, through the use of alcohol depletion procedures.

In the context of the present invention, a “wort” is taken to mean the extract of a carbohydrate source, for example malt, after removal of insoluble constituents, to which water and hop is added, and which is boiled. After boiling with hop, the so called finished wort is obtained. After cooling down, the boiled wort is present in the form of pitching wort. The wort is prepared by means of mashing, run-off, boiling and treatment of the wort. The aim of wort preparation is to convert the initially insoluble constituents of the carbohydrate source, in particular of malt, into soluble fermentable substances, separate the remaining solid constituents, and then add the spice, i.e. the hop. In the process of mashing, the initially shredded carbohydrate source, in particular malt, is mixed with brewing liquor. Subsequently, a targeted enzymatic conversion of ingredients of the carbohydrate source is carried out in the process of mashing in a specific temperature-time program, with the most important process being the complete degradation of starch to fermentable sugars such as glucose, maltose or maltotriose, and non-fermentable dextrins. The optimal temperature for maltose formation is 60° C.-65° C., and 70° C.-75° C. for dextrin formation. The temperature determines the final degree of fermentation of the wort for each type of beer. After run-off and the addition of sugar to the remains by means of hot brewing liquor (78° C.), the wort is boiled for 60 min to 100 min under addition of hop, whereby between approx. 150 and 500 g hop per hl being added depending on the type of beer to be produced. The original wort content is then adjusted by evaporating approx. 6-10% of the starting quantity. The boiling process is accompanied by sterilization, coagulation of the proteins, isomerization of bitter substance in the hop, and formation and, to some extent, evaporation of aroma substances. After the addition of hop, the boiled wort is subjected to whirlpool and/or filtration treatment to remove trub substances. After cooling, which is usually effected in plate heat exchangers, the cold-trub is partly removed and the remainder is aerated intensively to supply oxygen to the microorganisms used for fermentation. Immediately thereafter, as suitable microorganism capable of fermentation, for example a yeast, is added to the wort.

A “carbohydrate source” is taken to mean carbohydrate-containing materials, the carbohydrates of which can, at least partly, be converted into fermentable soluble sugars, such as glucose, maltose or maltotriose, during the production of the wort, which then are utilized as carbohydrate source in the process of fermentation by microorganisms, in particular yeasts. In a preferred embodiment of the invention, the carbohydrate source used is malted grains, raw grains or a mixture thereof.

Malted grains preferably correspond to grains and seeds of barley, wheat, rye, oats, millet, triticale, rice, sorghum and/or corn (maize) that have been subjected to a malt production procedure. Accordingly, the term, “malted grains”, comprises malt also. Raw grain preferably corresponds to grains and seeds of barley, wheat, rye, oats, millet, sorghum, triticale, rice and/or corn (maize) that were shredded, but not malted.

During the production of malt, i.e. during the malting process, the original solid grain structure is destroyed ad enzymes facilitating the biochemical process required during beer production are formed. In classical beer production, the starting materials must be saccharified prior to fermentation. The inherent hydrolytic enzymes of malt, such as amylases, maltases, etc., which convert the starch to non-fermentable dextrins and fermentable glucose, maltose, and maltotriose, are used for this purpose. In the process of malt preparation, the steeped cereals are allowed to germinate at 12° C. to 18° C. and the germination process is interrupted as soon as the formation of enzymes and dissolution processes have proceeded to the desired degree. Mainly glucanases, which degrade the cell wall to low molecular carbohydrates, proteolytic enzymes which degrade proteins, amylases which degrade starch, and phosphatases which cleave phosphoric acid esters, are formed in the process of germination. These processes are initiated by the uptake of water and oxygen. Owing to the activity of the enzymes, the cell walls in the grain are degraded such that the grain becomes increasingly tender. The germination process is controlled by means of the parameters, degree of steeping, i.e. water content of the germinating goods, and germination temperature, whereby the temperature control is effected by means of the ambient air temperature. In contrast, the germination time and air conditions are insignificant. The biochemical conversions in the long malt or green malt are interrupted as soon as they have proceeded to a desired degree. This is effected by applying elevated temperatures at a high throughput of air, whereby respiration and the dissolution of malt are interrupted by the removal of water. Pre-drying at 40 to 50° C. (withering) is used to lower the water content from above 50% to 10 to 12%. Subsequently, the temperature is raised to approx. 80 to 85° C. and the water content of the malt is adjusted to approx. 4 to 5%. This process is called kilning. The temperature-time control used during germination and kilning determines the individual malt types, namely light malt, medium-colored malt, dark malt, light and dark caramel malt, color malt, and chitmalt.

A “fermentation” or a “fermentation process” is taken to mean the microorganism-effected enzymatic degradation of carbohydrates in the complete or partial absence of oxygen. In alcohol fermentation, hexoses such as glucose are degraded to form ethanol and carbon dioxide. In beer production, the fermentation process usually proceeds in two steps. The main fermentation is initiated by adding microorganisms, in particular yeasts, for example bottom fermentation yeasts or top fermentation yeasts. The yeast sediments on the bottom or in the tapered part of the fermentation tank at the end of the main fermentation. The young beer obtained in the main fermentation is then cooled down again and subjected to a secondary fermentation, in which the residual extract is fermented and the beer is clarified. The wort flavor disappears during the fermentation, whereby in particular during the secondary fermentation the pure beer flavor develops. This process is also called conditioning. The fermentation can be influenced by performing the process at different fermentation temperatures, as a top fermentation or bottom fermentation production, as an open or closed fermentation, etc.

In one embodiment of the present invention, the method according to the invention is used to produce a dark low-alcohol or alcohol-free beer or a light low-alcohol or alcohol-free beer. In the context of the present invention, an “alcohol-free beer” is taken to mean a beer with an alcohol content of approx. 0.5% that preferably has 7-8% original wort. In the present teaching, all mentions of % are meant to be % by volume, unless stated otherwise. In the context of the present invention, a “low-alcohol beer” is taken to mean a beer with an alcohol content of less than 6%, in particular less than 5%, preferably less than 4%, particularly preferred less than 3%, and most preferred less than 1% to 2%.

In a further embodiment, top fermentation or bottom fermentation beer is produced through the use of the method according to the invention. Bottom fermentation beer is obtained by bottom fermentation, whereby the yeast sediments at the bottom of the vessel at the end of the fermentation from where it can be separated off. Top fermentation beer is beer obtained by top fermentation, in which the yeast rises at the end of the fermentation and can be separated off on the top to the extent possible.

A further embodiment provides the wort to be mixed with a palatinose-containing mixture or palatinose at a ratio of carbohydrate source, in particular malt to palatinose of 2:1 to 1:1 before, during or after the fermentation. In particular, the invention provides the palatinose-containing mixture or the palatinose to be added in the form of syrup, in solution or in the form of a crystalline solid.

Palatinose (6-O-α-D-glucopyranosylfructose; isomaltulose) is a naturally-occurring, for example in honey, disaccharide ketose. According to DE 44 14 185 C1, palatinose can be produced from sucrose on an industrial scale by simple enzymatic rearrangement, for example through the use of immobilized bacterial cells, in particular of the species Protaminobacter rubrum, Erwinia rhapontici, and Serratia plymuthica, or a sucrose-isomerase isolated therefrom. Palatinose is a reducing sugar that is not or only very poorly fermented, for example, by Saccharomyces cerevisiae, S. carlsbergensis, S. diastaticus or Brettanomyces intermedius. The solubility of palatinose in water is 0.49 g palatinose per g of water. The sweetening power of palatinose is only approx. ⅓ of the sweetening power of sucrose.

A palatinose-containing mixture is a combination of palatinose and at least one further carbohydrate, for example fructose, glucose, sucrose, trehalulose, isomaltose, isomelizitose, oligosaccharides with a degree of polymerization of 3 or 4 or even higher, or mixtures thereof. In a preferred embodiment, the palatinose-containing mixture is the sucrose isomerization product that is obtained by means of transglucosidation of sucrose, preferably through the use of dead or viable cells of Protaminobacter rubrum or enzyme extracts prepared therefrom. Accordingly, palatinose-containing mixtures that are preferred according to the invention can, in a development of the invention, comprise approx. 79-85% palatinose, 8-10% trehalulose, 0.5-2% sucrose, 1-1.5% isomaltose, oligosaccharides with a degree of polymerization of 3 or higher, 2.5-3.5% fructose, and 2.0-2.5% glucose, whereby these numbers relate to the percentage solids content.

Since microorganisms such as Saccharomyces cerevisiae, Saccharomyces carlsbergensis, S. diastaticus or Brettanomyces intermedius assimilate and metabolize palatinose not at all or only with much difficulty, the addition of palatinose or of the palatinose-containing mixture before or during the fermentation provides for the alcohol content of the beverage produced in the fermentation to be lower as compared to a normal beer such that an alcohol-free or low-alcohol beer is obtained. The addition of palatinose or of the palatinose-containing mixture after the fermentation achieves mainly a sweetening effect such that the alcohol-free or low-alcohol beer produced in the fermentation is converted into an alcohol-free or low-alcohol beer-like soft drink, in particular a beer-mix beverage.

A particularly preferred embodiment of the invention provides the fermentation process to be carried out as a mixed fermentation involving the use of different microorganisms. It is particularly preferred to carry out the mixed fermentation through the use of at least two different microorganisms, in particular two different yeasts, for example one top fermentation and one bottom fermentation strain of S. cerevisiae or one S. cerevisiae strain and one S. diastaticus strain or one S. cerevisiae strain and one Brettanomyces intermedius strain. Obviously, it is also possible to use three, four or even more different microorganisms for mixed fermentation.

A further particularly preferred embodiment of the invention provides the fermentation process to be carried out through the use of at least one yeast and at least one acid-forming bacterium selected from the group consisting of representatives of Lactobacillus sp., Acetobacter sp., and Gluconobacter sp.

A preferred development of this embodiment provides the fermentation to be carried out through the use of S. cerevisiae and/or S. diastaticus and/or Brettanomyces intermedius and one representative of Lactobacillus. Lactobacilli, also known as lactic acid bacteria, are capable of lactic fermentation. The use of lactobacillus effects that fewer fermentable sugars are available to the yeasts such that less alcohol is generated during alcohol fermentation by the yeasts. This reduces the alcohol content of the beverages even further. The low-alcohol or alcohol-free beers or beer-like beverages produced by means of this type of fermentation are characterized by their mildly sour flavor that is similar to “Berliner Weige”.

A further preferred development of this embodiment provides the fermentation to be carried out through the use of S. cerevisiae and/or S. diastaticus and/or Brettanomyces intermedius, and a representative of Acetobacter. The genus Acetobacter comprises, in a narrower definition, the acetic acid bacteria that are capable of generating acetic acid by oxidizing ethanol. The use of Acetobacter in alcohol fermentation by yeasts causes the generated alcohol to be reduced. Accordingly, the use of yeasts and Acetobacter effects, on the one hand, a reduction of the alcohol level attained in the yeast fermentation, and, on the other hand, conveys a slightly sour flavor to the low-alcohol or alcohol-free beers or beer-like beverages that is clearly different from the flavor of the beverages produced through the use of Lactobacillus.

A further preferred development of this embodiment provides, for example, for the fermentation to be carried out with the use of S. cerevisiae and/or S. diastaticus and/or Brettanomyces intermedius and one representative of Gluconobacter. Gluconobacter is capable of oxidizing ethanol and glucose to acetic acid and gluconic acid, respectively. In a mixed fermentation by means of at least one yeast and at least one representative of Gluconobacter, Gluconobacter is capable, on the one hand, of reducing the level of the starting substrate glucose that is needed for the yeast fermentation such that less alcohol is generated from the very beginning, and on the other hand, of reducing the ethanol generated by yeast fermentation such that the alcohol content of the beer-like beverages produced is clearly reduced. The low-alcohol or alcohol-free beers or beer-like beverages produced by this mixed fermentation also have a pleasant slightly sour flavor.

The invention also provides for the fermentation process of the method according to the invention to be carried out by means of a single type of microorganism, in particular by a yeast.

The present invention also relates to a low-alcohol or alcohol-free beer or beer-like soft drink produced by means of the method according to the invention. In a preferred embodiment, this is a light low-alcohol or alcohol-free beer or beer-like beverage or a dark low-alcohol or alcohol-free beer or beer-like beverage. The low-alcohol or alcohol-free beer or beer-like beverage can be provided in the form of either a top fermentation or a bottom fermentation beer.

The present invention also relates to a beer-mix beverage containing an herb component, aroma component, caffeine component, dye component, amino acid component, acid component for consumption, acid component and/or fruit component, as well as
(a) a low-alcohol or alcohol-free beer or beer-like soft drink, produced by means of a method according to the invention, and a sugar component, in particular a sucrose-containing sugar component;
(b) beer, alcohol-free, low-alcohol or alcohol-enriched beer or beer-like soft drink, and palatinose or a palatinose-containing ingredient; or
(c) low-alcohol or alcohol-free beer or beer-like soft drink according to the invention and palatinose or a palatinose-containing ingredient.

According to the invention, the palatinose-containing ingredient is a palatinose-containing mixture, i.e. a combination of palatinose and at least one further carbohydrate, for example fructose, glucose, sucrose, trehalulose, isomaltose, isomelizitose, oligosaccharides with a degree of polymerization of 3 or 4 or even higher, or mixtures thereof, whereby the palatinose-containing ingredient preferably is the sucrose isomerization product that is obtained by means of transglucosidation of sucrose, preferably with the use of dead or viable cells of Protaminobacter rubrum or enzyme extracts prepared therefrom. Accordingly, palatinose-containing mixtures preferred according to the invention can, in a development of the invention, comprise approx. 79-85% palatinose, 8-10% trehalulose, 0.5-2% sucrose, 1-1.5% isomaltose, oligosaccharides with a degree of polymerization of 3 or higher, 2.5-3.5% fructose, and 2.0-2.5% glucose, whereby these numbers relate to the percentage solids content.

“Herb components” are taken to mean, in particular, extracts, solutions or essences of plant parts of, for example, aniseed, valerian root, stinging nettle, blackberry leaves, strawberry leaves, fennel, lady's mantle, silverweed, ginseng, rosehip, hibiscus blossoms, raspberry leaves, elder, hop vine, ginger, St. John's wort, chamomile, coriander, spearmint, Lapacho plant, lavender, lemon grass, marjoram, mallow, balm, mistletoe, peppermint, marigold, rosemary, gentian, yarrow, thyme, hyssop, cinnamon, etc.

According to the invention, “fruit components” are taken to mean, in particular, extracts of fruit such as apples, bananas, pears, pineapples, oranges, grapefruit, cherries, sour cherries, limes, lemons, passion fruit, peaches, sea buckthorn, raspberries, strawberries, blackberries, currants, gooseberries, kiwi fruit, etc.

According to the invention, the beer-mix beverage can also contain natural or nature-identical odor substances and/or flavor substances as aroma components. This can be, in particular, products produced from natural starting materials, synthetically produced products or mixtures thereof, for example ethereal oils from plants or fruit such as citrus oil, peppermint oil or cloves oil, fruit essences, aroma-conveying fruit juices, aniseed, menthol, eucalyptus, etc.

The dye components are compounds and substances that are used for color correction and/or generation of a pleasant appearance of the beer-mix beverage according to the invention, whereby natural or synthetically produced dyes can be used. The dye components used according to the invention can, for example, be dyes of plant origin, such as carotinoids, flavonoids or anthocyans, dyes of animal origin, inorganic pigments such as iron oxide pigments, products of enzymatic browning and non-enzymatic browning, heating products such as sugar coloring, or synthetic dyes such as azo-, triphenylmethane, indigoid, xanthene or quinoline compounds. Suitable synthetic dyes are for example erythrosine, indigo carmine or tartrazine.

According to the invention, the amino acid components are, in particular, mixtures of essential amino acids that cannot be synthesized by the human body or can be provided at insufficient rate only and thus must be supplied with food. Essential amino acids, are, in particular, His, Iie, Leu, Lys, Thr, Trp, and Val.

The acid components used according to the invention are, in particular, those acids that contribute a slightly sour flavor to the beverage age according to the invention and/or contribute to improving the storage stability (shelf-life).

Particularly preferred acids for consumption are, in particular, citric acid, malic acid, lactic acid, tartaric acid, and similar. Acid components for consumption can, contribute to the beer-mix beverage according to the invention a further typical flavor component besides the slightly sour flavor component. Citric acid, for example, can convey a citrus-like flavor to the beer-mix beverage according to the invention. Malic acid can convey an apple-like flavor component to the beer-mix beverage according to the invention.

In a preferred embodiment, the beverages according to the invention can be provided in the form of carbonated beverages, i.e. they can contain carbonic acid or carbon dioxide.

In a particularly preferred embodiment, the beer-mix beverages according to the invention can also contain caffeine components. According to the invention, in particular extracts or preparations of coffee beans, of the tea plant or parts thereof, of the mate plant or parts thereof, of cola nut, of cocoa beans or guarana paste are used as caffeine components. The effect of the addition of the caffeine components to the beer-mix beverages according to the invention is that these have a stimulating effect on the cerebral cortex and the respiratory and circulatory center.

The present invention also relates to a functional beer-like beverage containing microorganisms and palatinose. Accordingly, a functional beer-like beverage is provided according to the invention that is produced by adding at least one culture of a probiotic microorganism, for example Lactobacteria, bifidobacteria, so-called “synbiotics”, etc., to a beer-like alcohol-free or low-alcohol beverage that is preferably produced through the use of the method according to the invention. Depending on the use, the cultures of probiotic microorganisms are added as viable cultures or as dry cultures or as permanent cultures.

The present invention also relates to the use of palatinose or palatinose-containing ingredients, as an option, jointly with sugar syrups for producing beer-mix beverages or of sugar syrups for producing beer-mix beverages. The invention shall be described in more detail by the following examples.

### EXAMPLE 1

Production of a Malt Beverage with Palatinose

a) Brewing of a draft beer that is cooled, filtered and filled in containers without fermentation and without adding cultures of organisms. A palatinose-containing syrup or a palatinose-containing solution is added during boiling, before filtration or right before filling in containers.

b) Production of a malt beverage or malt beer with palatinose according to the yeast-cold-contact procedure or a procedure adapted from that procedure.

The finished wort of any original wort content is cooled to 0° C. and, after adjustment of the pH by biological acidification, approx. 30×10⁶ yeast cells are added. The yeast-wort mixture is not aerated. The oxygen content is further reduced by adding CO₂. The exposure time of yeast and wort is 24-48 h at temperatures around 0° C. A beverage is thus obtained with an alcohol content of <0.5%-1.5% by vol. to which palatinose is added to improve the flavor. Palatinose is added in crystalline or dissolved form.

### EXAMPLE 2

Production of a Lean Alcohol-Free Beverage with Palatinose

A beer produced by classical means is alcohol-depleted according to the prior art, for example by dialysis, reverse osmosis, vacuum evaporation, etc. In order to improve the organoleptic appearance, palatinose or a palatinose solution is added to this beverage before or after alcohol-depletion at a low concentration of 1 g-5 g palatinose per 100 ml of the final beverage. The beverage thus attains more body and volume.

### EXAMPLE 3

Production of a Reduced-Alcohol Beer with Palatinose

A beer produced according to the prior art is alcohol-depleted through the use of one of the procedures described in Example 2. The alcohol depletion is not completed, though, but allowed to proceed only to a residual alcohol content of approx. 1% by vol.-3% by vol. As before, a small amount of palatinose in crystalline or predissolved form is added to this beer up to a final concentration of approx. 1 g to 5 g per 100 ml.

### EXAMPLE 4

Production of a Low-Alcohol Beer with Palatinose

In a beer brewed with any malt variety containing 100% bulk malt or up to 40% raw grain (non-malted grain, for example corn (maize), rice, barley, wheat, oat, millet, sorghum), the extract fraction to be expected from the customary raw materials is partly substituted for by palatinose.

The substitution is carried out by adding crystalline palatinose to a beer with a low original wort content (approx. 5-10%) in the wort copper or whirlpool. The ratio of palatinose to extract from the bulk should be between 1:4 and 2:1. The beers are fermented, stored, and filled in containers after or without being filtered, all according to the prior art. However, they contain only ⅓ to ⅔ of the alcohol content expected of beers that were brewed according to the prior art.

The substitution can also be carried out by blending 100 hl of beer with 100 hl of a palatinose-containing solution at any time. The palatinose content of the solution is approx. 0.5 to 2-fold the amount of extract of the beer wort used for beer production. The blending can be carried out at any step in the procedure between the brewing house and the filling process.

### EXAMPLE 5

Production of Beer-Mix Beverages with Palatinose

a) Any type of beer is produced and palatinose is added at any time in the brewing process. Prior to being filled in containers, these beers are mixed with aroma concentrates. Mixing with aroma substance-containing sugar syrups is not required, since the beers possess sufficient residual sweetness owing to the palatinose fraction.

b) Beers brewed according to the prior art are mixed with an aromatized fruit syrup with or without being filtered. Deviating from the prior art, the sugar or the sweetener in these syrups is fully or partly replaced by palatinose.

1-17. (canceled)

18. A process for the production of a low-alcohol or alcohol-free beer or of a beer-like refreshment beverage, a wort being produced in a first step by mixing brewing water, hops and a carbohydrate source, the wort being boiled in a second step and the wort being subjected to a fermentation process in a third step, a palatinose-containing mixture or palatinose being added before, during or after the fermentation process, characterized in that at least one microorganism selected from the group consisting of Saccharomyces diastaticus and Brettanomyces intermedius is used for the fermentation.

19. The process as claimed in claim 18, wherein the carbohydrate source is employed in the form of malted grain or of unmalted grain plus malted grain.

20. The process as claimed in claim 18, wherein a dark or a light beer is produced.

21. The process as claimed in claim 19, wherein a top-fermenting or bottom-fermenting beer is produced.

22. The process as claimed in claim 18, wherein the wort is mixed with the palatinose-containing mixture or palatinose in a ratio of carbohydrate source to palatinose of 2:1 to 1:1.

23. The process as claimed in claim 18, wherein the palatinose-containing mixture or the palatinose is added as a syrup, in solution or in the form of a crystalline solid.

24. The process as claimed in claim 18, wherein the fermentation process is carried out as a mixed fermentation using various microorganisms.

25. The process as claimed in claim 24, wherein at least two said microorganisms are employed.

26. The process as claimed in claim 24, wherein the fermentation is carried out using at least one yeast and at least one acid-forming agent.

27. The process as claimed in claim 26, wherein the acid-forming agent is selected from the group consisting of Lactobacillus sp., Acetobacter sp. and Gluconobacter sp.

28. The process as claimed in claim 18, wherein the fermentation process is carried out by means of a single organism.

29. A low-alcohol or alcohol-free beer or beer-like beverage produced by the process as claimed in claim 18.

30. A low-alcohol beer or beer-like refreshment beverage as claimed in claim 29, wherein the beverage is a light or dark beer or beer-like beverage.

31. A beer mixed beverage comprising at least one of a herbal, flavoring, caffeine, colorant, amino acid, pleasure consumption acid and fruit component, and
(a) a low-alcohol or alcohol-free beer or beer-like refreshment beverage, produced by the process as claimed in claim 18, and a sugar component, or
(b) a low-alcohol or alcohol-free beer or beer-like refreshment beverage as claimed in claim 18 and palatinose or a palatinose-containing ingredient.

32. A functional beer-like beverage produced by the process as claimed in claim 1, comprising microorganisms and palatinose.

33. The process as claimed in claim 22, wherein malt is used as the carbohydrate source.

34. The beer mixed beverage of claim 31, wherein the sugar component is a sucrose-containing sugar component.
